(19) United States
(12) Patent Application Publication
(10) Pub. No.: US 2012/0187185 A1
(43) Pub. Date: Jul. 26, 2012

(54) SYSTEM AND METHOD FOR DETECTING COUNTERFEIT PRODUCTS AND DOCUMENTS, AND TRACKING AND AUTHENTICATING DOCUMENTS

(76) Inventor: Eugene Sayan, Massapequa, NY (US)

(21) Appl. No.: 13/275,755

(22) Filed: Oct. 18, 2011

Related U.S. Application Data
(60) Provisional application No. 61/434,759, filed on Jan. 20, 2011.
(60) Provisional application No. 61/548,325, filed on Oct. 18, 2011.
(60) Provisional application No. 61/437,452, filed on Jan. 28, 2011.

(51) Int. Cl. G06K 5/00; G06K 1/00

(52) U.S. Cl. 235/375; 235/487

(57) ABSTRACT

Readable indicia, such as, a two-dimensional (2D) quick response (QR) code, is affixed to a product or a document. A scanning device, such as a mobile phone equipped with a camera, scans the readable indicia to obtain data stored in the readable indicia. The data is used to detect counterfeit products and documents, and track and authenticate documents.

### CROSS-REFERENCE TO RELATED PATENT APPLICATION

This application claims priority to and the benefit of Provisional Application Ser. No. 61/434,759, filed on Jan. 20, 2011, and Provisional Application Ser. No. 61,437,452, filed on Jan. 28, 2011, and Provisional Application Ser. No. 61/548,325, filed on Oct. 18, 2011, the contents of which are herein incorporated by reference in their entirety.

### BACKGROUND

1. Technical Field

The present disclosure relates to a system and method of detecting counterfeit products and documents, and tracking and authenticating documents.

2. Discussion of Related Art

According to the International Anti-Counterfeiting Coalition, counterfeit products are part of a multi-billion dollar industry, and account for 7% of worldwide trade. Counterfeit products harm product manufacturers by way of lost sales and brand dilution. In addition to counterfeit products, counterfeit documents such as, for example, counterfeit checks, diplomas, and birth certificates are frequently used to carry out fraudulent activities. The detection of counterfeit products and documents presents many challenges.

Affixing a readable indicia to a product or document allows information pertaining to the product or document to be linked to the product or document. Various methods of detecting counterfeit products and documents may be performed using the information stored in a readable indicia. A matrix barcode, also termed a two-dimensional (2D) barcode, is a 2D readable indicia capable of representing information. It is similar to a linear one-dimensional (1D) barcode, but can represent more data per unit area. A quick response (QR) code is an example of a matrix code, which was initially developed for logistics and car parts supply chain management by the Denso Wave™ Corporation. A barcode scanner can be used to scan the matrix code and interpret the embedded information, aiding in the detection of counterfeit products and documents. In addition, due to the incorporation of cameras into mobile devices such as, for example, smartphones, personal digital assistants (PDAs), and tablet personal computers (PCs), mobile devices have the ability to function as a barcode scanner.

### BRIEF SUMMARY

A method of product counterfeit detection includes disposing a readable indicia comprising a unique identification (ID) code on a product, generating scan data upon scanning the readable indicia with a scanning device, wherein the scan data comprises the unique ID code, a scanning device identification (ID) code and a scan location, transmitting the scan data to a remote server, linking the unique ID code, the scanning device ID code, and the scan location in an electronic database at the remote server, incrementing a first counter upon determining that the scanning device ID code and the scan location have not been previously linked to the unique ID code in the remote electronic database, and flagging the unique ID code as counterfeit upon determining that the first counter exceeds a counterfeiting threshold.

A method of product counterfeit detection includes disposing a readable indicia comprising a unique identification (ID) code on a product, generating scan data upon scanning the readable indicia with a scanning device, wherein the scan data comprises the unique ID code, a scanning device identification (ID) code and a scan location, transmitting the scan data to a remote server, linking the unique ID code, the scanning device ID code, and the scan location in an electronic database at the remote server, and flagging the unique ID code as counterfeit upon determining that the unique ID code is linked to a different scanning device ID code and a different scan location in the remote electronic database.

A grey market commerce detection method includes disposing a readable indicia comprising a unique identification (ID) code on a product, transmitting product exclusivity data to a remote server, wherein the product exclusivity data indicates whether the unique ID code is designated for sale in an exclusive market or a nonexclusive market, generating scan data upon scanning the readable indicia with a scanning device, wherein the scan data comprises the unique ID code and a scan location, transmitting the scan data to the remote server, and flagging commerce as grey market commerce upon determining that the product was purchased in an exclusive market based on the scan location, and the product was not designated for sale in the exclusive market based on the product exclusivity data.

A product counterfeit detection system includes a print device configured to generate a readable indicia comprising a unique identification (ID) code to be assigned to a product, a scanning device configured to generate scan data upon scanning the readable indicia, wherein the scan data comprises the unique ID code, a scanning device identification (ID) code and a scan location, and a remote server comprising an electronic database and a processor, wherein the remote server is configured to receive the scan data from the scanning device, and the processor is configured to link the unique ID code, the scanning device ID code, and the scan location in the electronic database, increment a first counter upon determining that the scanning device ID code and the scan location have not been previously linked to the unique ID code in the electronic database, and flag the unique ID code as counterfeit upon determining that the first counter exceeds a counterfeiting threshold, wherein the print device, the scanning device, and the data server are distinct from each other.

A product counterfeit detection system includes a print device configured to generate a readable indicia comprising a unique identification (ID) code to be assigned to a product, a scanning device configured to generate scan data upon scanning the readable indicia, wherein the scan data comprises the unique ID code, a scanning device identification (ID) code and a scan location, and a remote server comprising an electronic database and a processor, wherein the remote server is configured to receive the scan data from the scanning device, and the processor is configured to link the unique ID code, the scanning device ID code, and the scan location in the electronic database, and flag the unique ID code as counterfeit upon determining that the unique ID code is linked to a different scanning device ID code and a different scan location in the electronic database, wherein the print device, the scanning device, and the data server are distinct from each other.

A grey market commerce detection system includes a print device configured to generate a readable indicia comprising a unique identification (ID) code to be assigned to a product, a scanning device configured to generate scan data upon scanning the readable indicia, wherein the scan data comprises the unique ID code and a scan location, and a remote server comprising an electronic database and a processor, wherein the remote server is configured to receive the scan data from the scanning device and receive product exclusivity data from the print device, wherein the product exclusivity data indicates whether the unique ID code is designated for sale in an exclusive market or a nonexclusive market, and the processor is configured to flag commerce as grey market commerce upon determining that the product was purchased in an exclusive market based on the scan location, and the product was not designated for sale in the exclusive market based on the product exclusivity data, wherein the print device, the scanning device, and the data server are distinct from each other.

A method of tracking and authenticating a document includes receiving public metadata and protected metadata corresponding to the document from an originating source, wherein access to the public metadata is unrestricted and access to the protected metadata is restricted to at least one authorized entity, generating private metadata comprising information indicating the originating source, wherein the private metadata is automatically altered upon a scan operation occurring, and cannot be altered otherwise, generating a readable indicia corresponding to the public, protected, and private metadata, and affixing the readable indicia to the document.

A method of detecting a counterfeit document includes receiving a request to print a document from a user, prompting the user to enter user-specified data as public metadata and protected metadata, receiving the user-specified data, generating private metadata, adding a checksum value to the public, protected, and private metadata, encrypting the public, protected, and private metadata, encrypting the public, protected, and private metadata and the checksum, generating a 2D QR code for the encrypted public, protected, and private metadata and the checksum, and printing the document with the 2D QR code.

A counterfeit document detection system includes a print device and a user application platform. The print device is configured to embed a 2D QR code on a document and print the document, wherein the 2D QR code includes public metadata, protected metadata, private metadata, and a checksum, the public, protected, and private metadata and the checksum are encrypted. The user application platform is adapted to configure a device to decrypt the encrypted public, protected, and private metadata and the checksum upon scanning the 2D QR code, and comparing the public metadata with data printed on the document.

A counterfeit detection system includes a print device, a secure remote server, and a user application platform. The print device is configured to embed a 2D QR code on a document and print the document, wherein the 2D QR code includes public metadata, protected metadata, and private metadata, and the public, protected, and private metadata are encrypted. The secure remote server is configured to receive the public, protected, and private metadata from the print device, store the public, protected, and private metadata, verify the checksum, encrypt the public, protected, and private metadata and the checksum, generate the 2D QR code, and transmit the 2D QR code from the secure remote server to the print device. The user application platform is adapted to configure a device to receive comparison results from the secure remote server when the 2D QR code on the document is scanned. When the 2D QR code is scanned, the secure remote server receives the encrypted public, protected and private metadata, and the checksum from the device having the user application platform, and the public, protected, and private metadata and the checksum are decrypted. The secure remote server ten validates the decrypted public, protected, and private metadata using the checksum.

A system for detecting a counterfeit document includes a print driver and a remote server. The print driver is configured to receive a request to print a document from a user, prompt the user to enter user-specified data, receive the user-specified data, and send the user-specified data to the remote server. The remote server is configured to add a checksum to the user-specified data using a checksum method selected from a plurality of methods based upon a client ID associated with the print driver, encrypt the user-specified data and checksum, return the encrypted data back to the print driver, and generate a 2D QR code for the document using the encrypted user-specified data, the checksum, and private document metadata generated by the print driver. The document with the 2D QR code is then printed.

A system for detecting a counterfeit document includes a print driver configured to receive a request to print a document from a user, prompt the user to enter user-specified data, receive the user-specified data, add a checksum to the user-specified data, encrypt the user-specified data and the checksum, generate a 2D QR code for the document using the encrypted user-specified data, the checksum, and private document metadata generated by the print driver, and print the 2D QR barcode.

### BRIEF DESCRIPTION OF THE SEVERAL VIEWS OF THE DRAWINGS

FIG. 1 is a block diagram illustrating a system for detecting counterfeit products and a system for tracking and authenticating documents, according to an exemplary embodiment of the present disclosure.

FIG. 2 illustrates a method of detecting mass product counterfeiting, according to an exemplary embodiment of the present disclosure.

FIG. 3 is a flow chart illustrating a method of incrementing a counter to determine whether to flag a unique ID number as counterfeit, according to an exemplary embodiment of the present disclosure.

FIG. 4 illustrates a table stored in a database and configured to store device ID information and location information corresponding to scanned unique ID numbers, according to an exemplary embodiment of the present disclosure.

FIG. 5 illustrates a method of detecting mass product counterfeiting, according to an exemplary embodiment of the present disclosure.

FIG. 6 illustrates a method of advanced product counterfeit detection, according to an exemplary embodiment of the present disclosure.

FIG. 7 illustrates a method of grey market commerce detection, according to an exemplary embodiment of the present disclosure.

FIG. 8 is a flow chart illustrating a method of determining whether grey market commerce has occurred, according to an exemplary embodiment of the present disclosure.

FIG. 9 illustrates a method of distributed document tracking and authentication, according to an exemplary embodiment of the present disclosure.

FIG. 10 illustrates an example of a check including a readable indicia embodied as a QR code, according to an exemplary embodiment of the present disclosure.

FIG. 11 illustrates a method of localized document tracking, authentication, and counterfeit detection, according to an exemplary embodiment of the present disclosure.

FIG. 12 illustrates a method of document tracking and authentication, and counterfeit detection, according to an exemplary embodiment of the present disclosure

FIG. 13 illustrates an example of a diploma including readable indicia embodied as a QR code, according to an exemplary embodiment of the present disclosure.

FIG. 14 is a computer system for implementing a method of detecting counterfeit products and documents, and tracking and authenticating documents, according to an exemplary embodiment of the present disclosure.

### DETAILED DESCRIPTION

Exemplary embodiments of the present disclosure will now be described more fully hereinafter with reference to the accompanying drawings. This disclosure, may however, be embodied in many different forms and should not be construed as limited to the exemplary embodiments set forth herein.

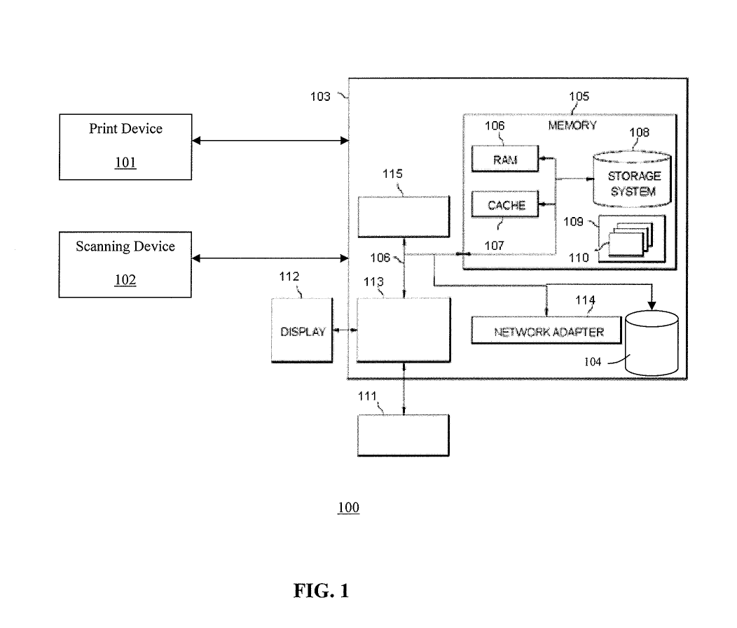

FIG. 1 is a block diagram illustrating a system for detecting counterfeit products and documents, and for tracking and authenticating documents, according to an exemplary embodiment.

Referring to FIG. 1, a system 100 for detecting counterfeit products and documents, and for tracking and authenticating documents as described below, includes a print device 101 configured to generate a readable indicia, a scanning device 102 configured to scan the readable indicia, and a remote server 103 in communication with the print device 101 and the scanning device 102.

The print device 101 includes a wired or wireless transmitter configured to communicate with the remote server 103, and may also include scanning means to scan the readable indicia. The scanning means may be, for example, a camera or a barcode reader configured to read a two-dimensional (2D) quick-response (QR) code, or a radio-frequency identification (RFID) radio configured to read an RFID tag. The print device 101 may further include an internal clock and location services. Information obtained using the internal clock and location services may be included in the readable indicia and/or transmitted to the remote server 103. The print device 101 may be, for example, a mobile phone, a laptop, or a personal computer.

The scanning device 102 may be a mobile device including, but not limited to, a smartphone, a tablet PC, or a PDA. The scanning device 102 may include, for example, a camera, an RFID radio, a cellular radio, a Wi-Fi radio, and a global positioning system (GPS) radio. The camera and RFID radio may be used to scan a readable indicia, and the cellular radio, Wi-Fi radio, and GPS radio may be used for location services. The scanning 102 device may further include an application (e.g., a mobile application) that enables scanning of the readable indicia on the products and documents, and communication with the remote server 103.

The remote server 103 may operate with numerous other general purpose or special purpose computing system environments or configurations. Examples of well-known computing systems, environments, and/or configurations that may be suitable for use with the remote server 103 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments.

The components of remote server 103 may include, but are not limited to, one or more processors or processing units 115 capable of encrypting and decrypting data, and calculating and verifying checksums, an electronic database 104 for storing data, a system memory 105, and a bus 106 that couples various system components including system memory 105 to processor 104. The bus 106 represents one or more of any of several types of bus structures, including a memory bus or memory controller, a peripheral bus, an accelerated graphics port, and a processor or local bus using any of a variety of bus architectures. By way of example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The remote server 103 may include a variety of computer system readable media. Such media may be any available media that is accessible by remote server 103, and it includes both volatile and non-volatile media, removable and non-removable media. The system memory 105 may include computer system readable media in the form of volatile memory, such as random access memory (RAM) 106 and/or cache memory 107. The remote server 103 may further include other removable/non-removable, volatile/non-volatile computer system storage media. By way of example, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 106 by one or more data media interfaces. The system memory 105 may include at least one program product having a set (e.g., at least one) of program modules that are configured to carry out the functions of embodiments of the invention. The memory 105 may also include a relational database for storing structured data.

A computer program 109, having one or more program modules 110, may be stored in memory 105, as well as an operating system, one or more application programs, other program modules, and program data. Each of the operating system, one or more application programs, other program modules, and program data or some combination thereof, may include an implementation of a networking environment. The program modules 110 may carry out the functions and/or methodologies of embodiments of the invention as described herein.

The remote server 103 may also communicate with one or more external devices 111 such as a keyboard, a pointing device, a display 112, etc.; one or more devices that enable a user to interact with the remote server 103; and/or any devices (e.g., network card, modem, etc.) that enable the remote server 103 to communicate with one or more other computing devices. Such communication can occur via Input/Output (I/O) interfaces 113. The remote server 103 may communicate with one or more networks such as a local area network (LAN), a general wide area network (WAN), and/or a public network (e.g., the Internet) via network adapter 114. As depicted, network adapter 114 communicates with the other components of remote server 103 via bus 106. It should be understood that although not shown, other hardware and/or software components could be used in conjunction with remote server 103. Examples, include, but are not limited to: microcode, device drivers, redundant processing units, external disk drive arrays, RAID systems, tape drives, and data archival storage systems, etc.

The system 100 may be built on a Cloud computing platform that includes all necessary hardware, software and services securely hosted at the remote server 103. All necessary computing resources may be exposed through XML SOAP (Simple Object Access Protocol) and Representational State Transfer (RESTful) Web Services. Downloadable mobile applications configured to interface with the system platform may be loaded onto the print device 101 and/or the scanning device 102.

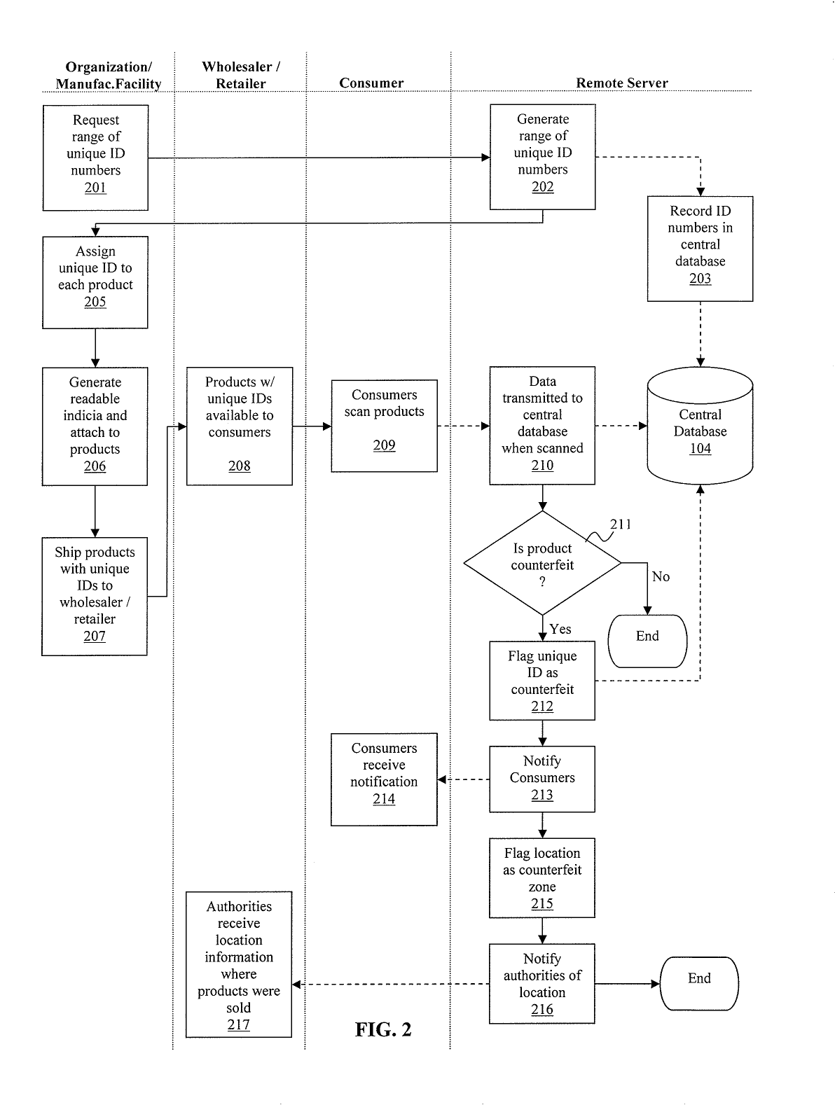

FIG. 2 illustrates a method of detecting mass product counterfeiting, according to an exemplary embodiment. Mass product counterfeit detection reflects counterfeit detection on a “one-to-many” level.

Referring to FIG. 2, synchronous communication is denoted by solid arrows and asynchronous communication is denoted by dotted arrows. In FIG. 2, an organization or a manufacturing facility requests a range of unique ID numbers for its products (block 201). The request is made to a remote server 103 maintained by a separate entity. Upon receiving the request, a range of unique ID numbers is generated at the remote server 103 (block 202) and recorded in a central database 104 at the remote server 103 (block 203). The range of unique ID numbers is transmitted from the remote server 103 back to the organization or manufacturing facility, and each unique ID number is assigned to a product (block 205). Readable indicia including the unique ID numbers are generated and attached to the appropriate products (block 206). In addition to the unique ID numbers, the readable indicia may include other information such as, for example, the name of the organization or manufacturing facility, and the manufacturing location. One having ordinary skill in the art will appreciate that the information included in the readable indicia is not limited thereto, and other pertinent information may also be included. The readable indicia may be, but is not limited to, a barcode such as, for example, a two-dimensional (2D) quick response (QR) code, or a near field communication (NFC) tag. The products including the readable indicia having the unique ID numbers are shipped to a wholesaler or a retailer (block 207), where the products are made available for purchase by consumers (block 208).

When a consumer scans the readable indicia on a product with the scanning device 102 (block 209), data is transmitted to the central database 104 where it is recorded (block 210). The data transmitted to the central database 104 may include, but is not limited to, the information stored in the readable indicia (e.g., the unique ID number, the name of the organization or manufacturing facility, and the manufacturing location), the device ID of the scanning device 102 used to scan the readable indicia, the location where the readable indicia was scanned, and the date and time the readable indicia was scanned. The number of times a readable indicia is scanned is (e.g., a scan count) and a counterfeiting threshold are used to determine whether the scanned product may be a counterfeit (block 211). The counterfeiting threshold may be any predefined number set by the organization or manufacturing facility. The counterfeiting threshold reflects the tolerance the organization or manufacturing facility has regarding the counterfeiting of a product. For example, an organization or manufacturing facility may determine that it is only concerned with the counterfeiting of a certain product if it is detected that the product has been counterfeited more than 1,000 times. In this case, the counterfeiting threshold is set to 1,000.

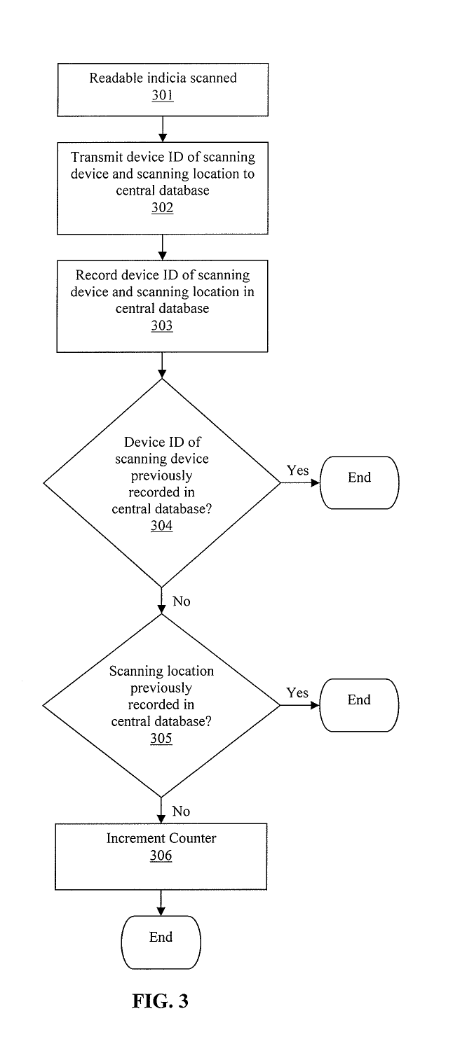

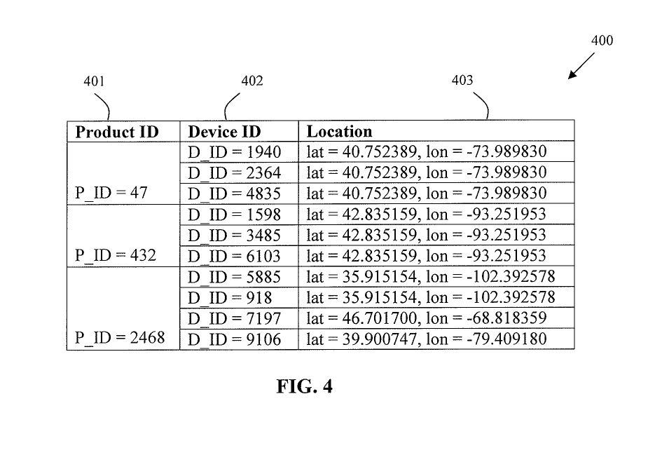

Once the number of times a unique ID number has been scanned exceeds the counterfeiting threshold, the unique ID number is flagged as counterfeit in the central database 104 (block 212). The process of determining whether a unique ID number is counterfeit is explained below in reference to FIGS. 3 and 4. Once a unique ID number has been flagged as counterfeit, consumers that subsequently scan the unique ID number receive a notification advising them that the product has been flagged as counterfeit (blocks 213, 214). The notification may prompt the user to return or exchange the product at the wholesaler or retailer where the product was purchased. Further, the location where a counterfeit ID number has been scanned may be flagged as a counterfeit zone for future investigation if the counterfeit ID number has been scanned at that location a certain number of times (e.g., a counterfeit zone quantity threshold may be predefined) (block 215). Local authorities may then be notified of the location of the counterfeit zone (block 216), and may also receive location information corresponding to where the products were sold (block 217).

FIG. 3 is a flow chart illustrating a method of incrementing a counter to determine whether to flag a unique ID number as counterfeit, according to an exemplary embodiment.

Referring to FIG. 3, each time a readable indicia is scanned (block 301), the device ID of the scanning device 102 and the scanning location are transmitted to the central database 104 (block 302), where they are recorded (block 303). If a readable indicia is scanned and it is determined that the device ID of the scanning device 102 has not been previously recorded in the central database 104 as having scanned the unique ID number associated with the scanned readable indicia (block 304), and the scanning location has not been previously recorded in the central database 104 (block 305) as a location where the unique ID number associated with the scanned readable indicia has previously been scanned, a counter corresponding to the scan count is incremented (block 306). If the device ID of the scanning device 102 has been previously recorded in the central database 104 as having scanned the unique ID number associated with the scanned readable indicia, or if the scanning location has been previously recorded in the central database 104 as a location where the unique ID number associated with the scanned readable indicia has previously been scanned, the counter is not incremented, since scans performed with the same scanning device 102 imply a single product scanned multiple times by the same scanning device 102 (e.g., an owner looking up information regarding the product) and scans occurring at the same location imply in-store pre-sale activity by consumers prior to the product being purchased. In an exemplary embodiment, date and time information may also be utilized, allowing for a specific date and time range to be used in the determination of whether a unique ID is counterfeit, and whether the counter should be incremented.

FIG. 4 illustrates a table storing device ID information and location information corresponding to scanned unique ID numbers, according to an exemplary embodiment. The table may be stored in the central database 104 of the remote server 103.

Referring to the table 400 in FIG. 4, three unique ID numbers are stored in a first column 401. Each unique ID number includes a list of device ID numbers corresponding to scanning devices that have already scanned the respective unique ID number in a second column 402, and a list of locations where the respective unique ID numbers were scanned in a third column 403. The table 400 is used to determine whether the counter corresponding to the scan count should be incremented, as described above. For example, consider a case where a product having a unique ID number P_ID=47 is scanned by a scanning device 102 having a device ID number D_ID=1940 at a location having coordinates lat=38.263488, lon=−83.979492. Since the product having the unique ID number P_ID=47 has already been scanned by the scanning device 102 having the device ID number D_ID=1940, the counterfeiting threshold is not incremented when the product is scanned. Next, consider a case where a product having a unique ID number P_ID=432 is scanned by a scanning device 102 having a device ID number D_ID=3995 at a location having coordinates lat=42.835159, lon=−93.251953. Since the product having the unique ID number P_ID=432 has already been scanned at the location having coordinates lat=42.835159, lon=−93.251953, the counter is not incremented when the product is scanned. Next, consider a case where a product having a unique ID number P_ID=2468 is scanned by a scanning device 102 having a device ID number D_ID=2121 at a location having coordinates lat=27.853324, lon=−97.272949. Since the product having the unique ID number P_ID=2468 has not been previously scanned by a device having the device ID number D_ID=2121, and has not been previously scanned at a location having coordinates lat=27.853324, lon=−97.272949, the counter is incremented. The format of each of the unique ID number, the device ID number, and the location coordinates shown in FIG. 4 are exemplary, and one having ordinary skill in the art will appreciate that any combination of numbers, letters, and/or symbols may be used for each of the unique ID number, the device ID number, and the location coordinates.

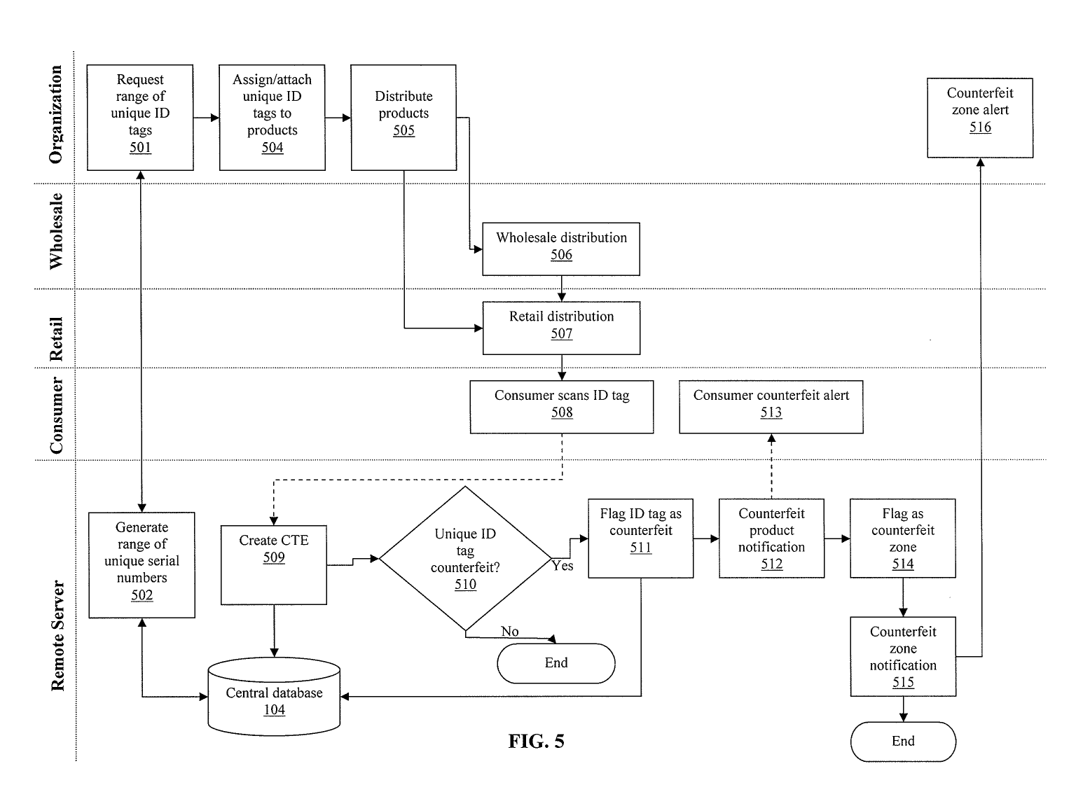

FIG. 5 illustrates a method of detecting mass product counterfeiting, according to an exemplary embodiment. Mass product counterfeit detection reflects counterfeiting on a “one-to-many” level.

Referring to FIG. 5, synchronous communication is denoted by solid arrows and asynchronous communication is denoted by dotted arrows. The method of detecting mass product counterfeiting shown in FIG. 5 begins at the organization level when an organization requests a range of unique ID tags for its products (block 501). The unique tags may be, but are not limited to, a barcode such as, for example, a QR code, or an NFC tag. Each unique ID tag may include, for example, an organization ID, a manufacturing facility ID, a product category (e.g., an EAI number or a UPC number), and a unique serial number, however the contents of the unique ID tags are not limited thereto. Once requested, a range of unique serial numbers is generated at a remote server 103 (block 502). The unique serial numbers are then recorded in a central database 104 at the remote server 103, and returned to the organization. The unique ID tags are assigned and attached to the manufactured products (block 504) by the organization and are then distributed to wholesalers and/or retailers (blocks 505-507), where they are made available for consumer purchase.

When the unique ID tag is scanned at the consumer level by a consumer (block 508), a critical tracking event (CTE) is created (block 509) at the remote server 103. The CTE results in data being transmitted to the central database 104 where it is recorded. The data transmitted to the central database 104 may include, but is not limited to, the information stored in the unique ID tag (e.g., the organization ID, the manufacturing facility ID, the product category, and the unique serial number), the device ID of the scanning device 102 used to scan the unique ID tag, the location where the unique ID tag was scanned, and the date and time the unique ID tag was scanned. Once the CTE has been created, it is determined whether the unique ID tag scanned by the consumer is counterfeit (block 510). The determination of whether a unique ID tag is counterfeit may be made using a counterfeiting threshold, the device ID of the mobile device used to scan the unique ID tag, and the location where the scan took place, as explained with reference to FIGS. 3 and 4. If it is determined that the unique ID tag is counterfeit, the tag is flagged as counterfeit in the central database 104 (block 511). Consumers that scan a unique ID tag after it has been flagged as counterfeit receive a notification advising them that the product has been flagged as counterfeit (blocks 512, 513). The notification may prompt the user to return or exchange the product at the wholesaler or retailer where the product was purchased. Further, the location where a counterfeit ID tag has been scanned may be flagged as a counterfeit zone for future investigation if the counterfeit ID tag has been scanned at that location a certain number of times (e.g., a counterfeit zone quantity threshold may be predefined) (block 514). A counterfeit zone notification may then be sent to the organization (blocks 515, 516).

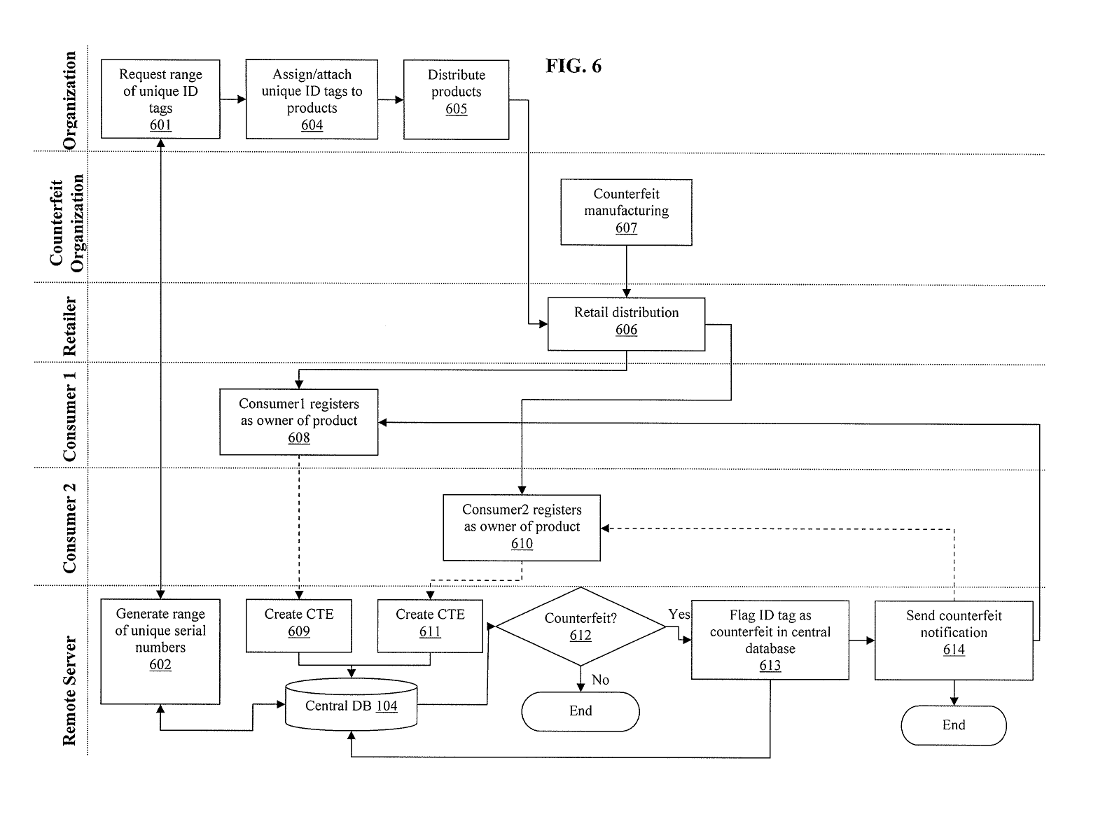

FIG. 6 illustrates a method of advanced product counterfeit detection, according to an exemplary embodiment. Advanced product counterfeit detection reflects counterfeiting detection on a “one-to-one” level.

Referring to FIG. 6, synchronous communication is denoted by solid arrows and asynchronous communication is denoted by dotted arrows. The method of advanced product counterfeit detection shown in FIG. 6 begins at the organization level when an organization requests a range of unique ID tags for its products (block 601). The unique tags may be, but are not limited to, a barcode such as, for example, a QR code, or an NFC tag. Each unique ID tag may include, for example, an organization ID, a manufacturing facility ID, a product category (e.g., an EAI number or a UPC number), and a unique serial number, however the contents of the unique ID tags are not limited thereto. Once requested, a range of unique serial numbers is generated at the remote server 103 which may be part of a cloud computing platform (block 602), recorded in a central database 104 at the remote server 103, and returned to the organization. The unique ID tags are assigned and attached to the manufactured products (block 604) by the organization and are then distributed to a retailer (blocks 605-606), where they are made available for consumer purchase. In addition to authentic products distributed to the retailer by the organization, counterfeit products may be manufactured and distributed to the retailer by a counterfeit organization (block 607).

When a first consumer purchases an authentic product (e.g., Product1 having IDTag1), the first consumer registers himself/herself as the owner of the product (block 608). The registration information provided by the first consumer may include, but is not limited to, the first consumer's name, phone number, and e-mail address. In addition, any time a consumer scans a unique ID tag, the date and time of the scan, the location of the scan, and a unique ID identifying the scanning device 102 used to scan the unique ID tag may be transmitted to and recorded in the central database 104. Upon registering the product, a critical tracking event (CTE) is created at the remote server 103 (block 609). The CTE results in data being transmitted to the central database 104, where it is recorded. The data transmitted to the central database 104 may include, but is not limited to, the information stored in the unique ID tag (e.g., the organization ID, the manufacturing facility ID, the product category, and the unique serial number), the device ID of the scanning device 102 used to scan the unique ID tag, the location where the unique ID tag was scanned, the date and time the unique ID tag was scanned, and the registration information provided by the first consumer.

When a second consumer purchases a counterfeit version of the authentic product purchased by the second consumer (e.g., Product1 having IDTag1), the second consumer also registers himself/herself as the owner of the product (block 610). The registration information provided by the second consumer may include, but is not limited to, the second consumer's name, phone number, and e-mail address. In addition, any time a consumer scans a unique ID tag, the date and time of the scan, the location of the scan, and a unique ID identifying the device used to scan the unique ID tag may be transmitted to and recorded in the central database 104. Upon registering the product, another CTE is created at the remote server 103 (block 611). The CTE results in data being transmitted to the central database 104, where it is recorded. The data transmitted to the central database 104 may include, but is not limited to, the information stored in the unique ID tag (e.g., the organization ID, the manufacturing facility ID, the product category, and the unique serial number), the device ID of the scanning device 102 used to scan the unique ID tag, the location where the unique ID tag was scanned, the date and time the unique ID tag was scanned, and the registration information provided by the second consumer.

Each time a CTE is created, an advanced counterfeit identification process is executed (block 612). The determination of whether a unique ID tag is counterfeit may be made by determining whether a unique ID tag (e.g., IDTag1 of Product1) has been scanned by different mobile devices at different locations, as described above in reference to FIGS. 3 and 4. The determination may be made based on a specific date and time range. If it is determined that a unique ID tag is counterfeit, the tag is flagged as counterfeit in the central database 104 (block 613) and a counterfeit notification is sent to every consumer that registered as the owner of the product (block 614). In addition, each registered user may be contacted by the organization to determine the location of the sale, and the location may be marked as a counterfeit zone for future investigation.

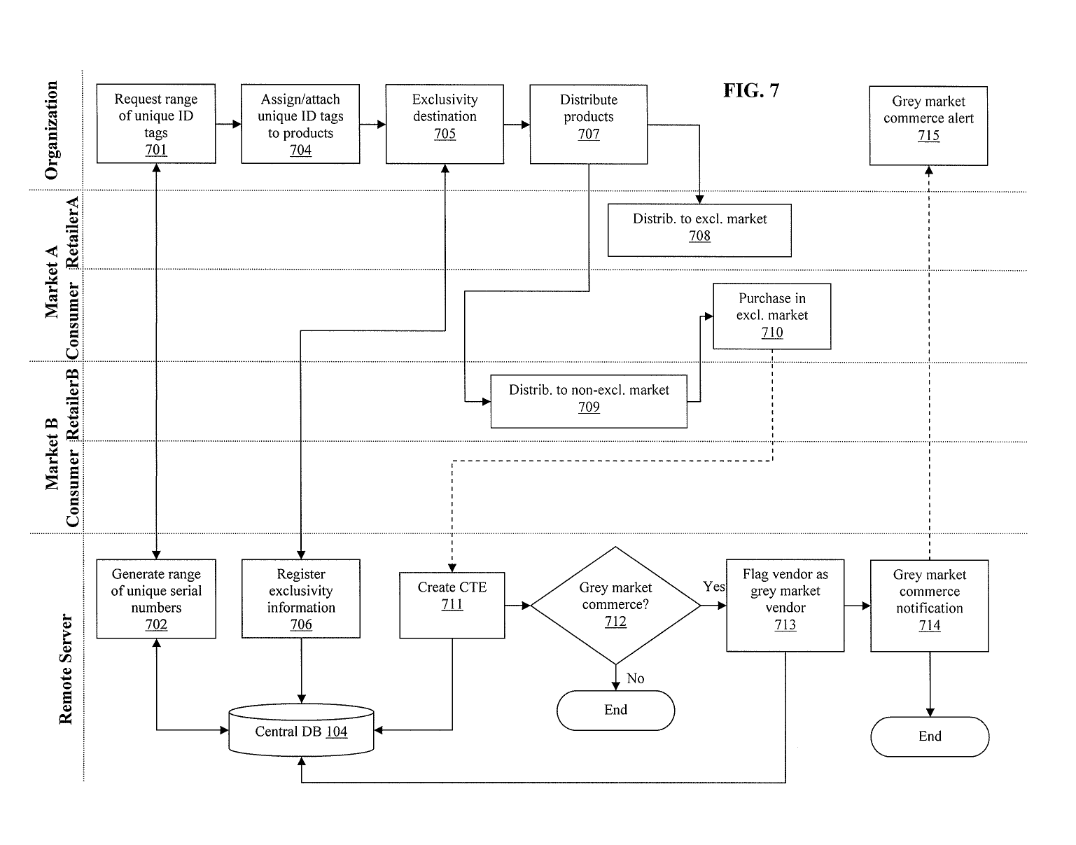

FIG. 7 illustrates a method of grey market commerce detection, according to an exemplary embodiment.

Grey market commerce detection involves manufacturers distributing certain products to retailers that have market exclusivity in specific geographic regions. For example, a manufacturer may distribute a product (e.g., Product1) to a first retailer (e.g., RetailerA) and a second retailer (e.g., RetailerB). RetailerA may have market exclusivity over Product1 in a first geographic location (e.g., MarketA), and RetailerB may have a non-exclusive right to sell Product1 in geographic locations other than MarketA. Thus, the sale of Product1 in MarketA by RetailerB, or by any other retailer, violates the market exclusivity agreement made between the manufacturer and retailers.

Referring to FIG. 7, synchronous communication is denoted by solid arrows and asynchronous communication is denoted by dotted arrows. The method of grey market commerce detection shown in FIG. 7 begins at the organization level when an organization requests a range of unique ID tags for its products (block 701). The unique ID tags may be, but are not limited to, a barcode such as, for example, a QR code, or an NFC tag. Each unique ID tag may include, for example, an organization ID, a manufacturing facility ID, a product category (e.g., an EAI number or a UPC number), and a unique serial number, however the contents of the unique ID tags are not limited thereto. Once requested, a range of unique serial numbers is generated at the remote server 103 (block 702). The serial numbers are then recorded in a central database 104 at the remote server 103, and returned to the organization. The unique ID tags are assigned and attached to the manufactured products (block 704) by the organization. ID tags for products destined to be sold in exclusive markets are registered for sale in their respective exclusive markets in the central database 104 prior to distribution (blocks 705, 706). The tagged products are then distributed to retailers and/or wholesalers (block 707), where they are made available for consumer purchase.

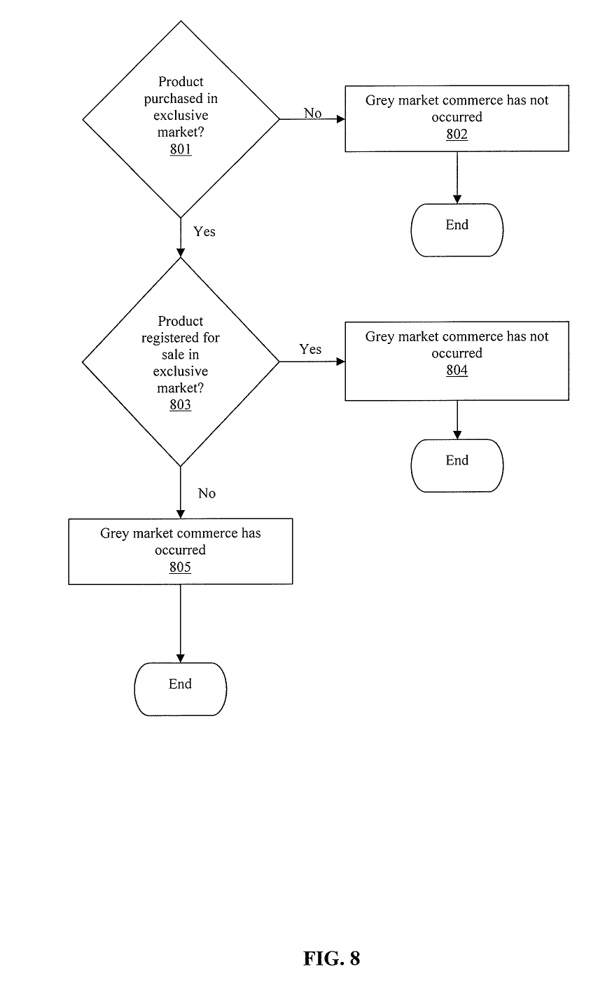

In the example shown in FIG. 7, the organization distributes a product (e.g., Product1) to a first retailer (e.g., RetailerA) in a first market (e.g., MarketA) (block 708), and to a second retailer (e.g., RetailerB) in a second market (e.g., MarketB) (block 709). MarketA is an exclusive geographic region where RetailerA has an exclusive right to sell Product1, and MarketB is a non-exclusive geographic region where any retailer may sell Product1. Thus, Product1 shipped to RetailerA is registered in the central database 104 for sale in MarketA, and Product1 shipped to RetailerB is not registered in the central database 104 for sale in MarketA. When a consumer purchases Product1 (block 710), a CTE is created at the cloud level (block 711). The CTE results in data being transmitted to the central database 104 where it is recorded. The data transmitted to the central database 104 may include, but is not limited to, the information stored in the unique ID tag (e.g., the organization ID, the manufacturing facility ID, the product category, and the unique serial number), the device ID of the scanning device 102 used to scan the unique ID tag, the location where the unique ID tag was scanned, and the date and time the unique ID tag was scanned. It is then determined whether grey market commerce has occurred (block 712). This determination is explained below with reference to FIG. 8. If grey market commerce is detected, the vendor that sold the product is flagged as a grey market vendor in the central database 104 (block 713). Subsequent scans may be filtered based on flagged vendors. A grey market commerce alert is then transmitted to the organization (blocks 714, 715).

FIG. 8 is a flow chart illustrating a method of determining whether grey market commerce has occurred, according to an exemplary embodiment.

Referring to FIG. 8, determining whether grey market commerce has occurred is based on the location where the product was purchased and the unique serial number corresponding to the product. For example, it is first determined whether the product was purchased in an exclusive market (block 801). If the product was not purchased in an exclusive market, grey market commerce has not occurred (block 802). If the product was purchased in an exclusive market, the central database 104 is checked to determine whether the unique serial number of the product is registered for sale in the exclusive market (block 803). If the unique serial number of the product is registered for sale in the exclusive market, grey market commerce has not occurred (block 804). If the unique serial number of the product is not registered for sale in the exclusive market, grey market commerce has occurred (block 805).

In addition to detecting counterfeit products, exemplary embodiments of the present invention may also detect counterfeit documents, as well as track and authenticate documents. Documents may include, for example, bank issued checks, payroll checks, diplomas, transcripts, claims checks, wills, deeds, legal briefs, birth certificates, and personal and corporate tax returns. Documents may be tagged with a readable indicia (e.g., a QR code or an NFC tag) that includes public metadata, protected metadata, private metadata, and a checksum value. In an exemplary embodiment, Pretty Good Privacy (PGP) encryption techniques may be used to encrypt the metadata values with a private/public key combination. PGP is a data encryption and decryption technique that provides cryptographic privacy and authentication for data communication.

According to exemplary embodiments, the readable indicia may include different types of metadata. The different types of metadata have different permissions, and are used to store different types of information. For example, the readable indicia on a document may include private metadata, protected metadata, and public metadata.

Private metadata includes information used for internal processing and for creating an audit trail. Creating an audit trail may include, for example, tracking devices used to scan a document, and tracking the date and time of each scanning. For example, private metadata is generated automatically by a device upon scanning a readable indicia. Private metadata cannot be generated or edited manually by a user. Private metadata may be used to redirect a user who scans a readable indicia to a customized microsite, without displaying the private metadata to the user. The private metadata may be deciphered by a remote server and relayed to a proprietary system, which in turn displays public information regarding the document, as well as any other relevant information, to the user. For example, in an exemplary embodiment, when a user scans a readable indicia on a diploma, an encrypted student ID (e.g., private metadata) is transmitted to a remote server and deciphered by a proprietary system, and a message alerting the user that the diploma is authentic (or not authentic) is displayed to the user. The encrypted student ID is not displayed to the user. Other relevant information (e.g., student transcripts) may also be displayed to the user.

Protected metadata includes information that is only visible to authorized users.

Public metadata includes information that does not have any restrictions, and can be shared with anyone. For example, public metadata does not include personal identifiable information (PII).

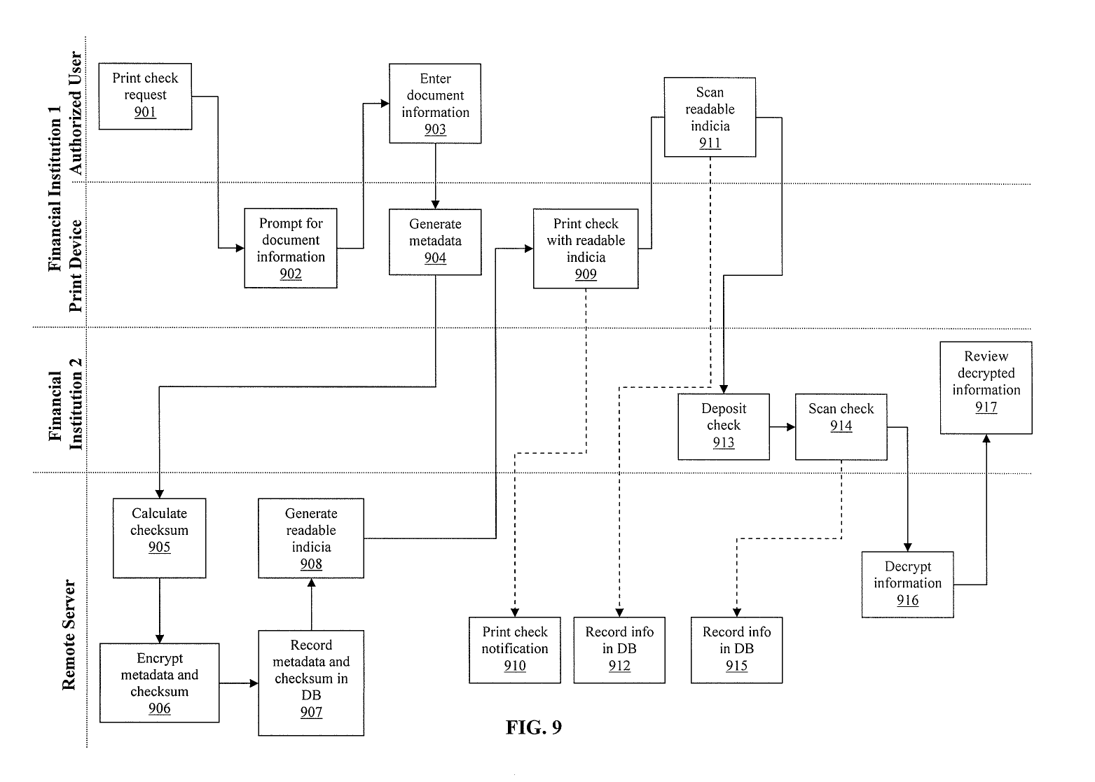

FIG. 9 illustrates a method of distributed document tracking, authentication, and counterfeit detection, according to an exemplary embodiment. For purposes of illustration, FIG. 9 shows the tracking and authentication of bank checks, and the detection of counterfeit bank checks using the counterfeit detection system. However, as will be appreciated by one having ordinary skill in the art, the method as described in reference to FIG. 9 is not limited to bank checks.

Referring to FIG. 9, distributed document tracking, authentication, and counterfeit detection utilizes a remote server 103. Using the method shown in FIG. 9, a readable indicia is printed and may be hidden or visibly displayed on a bank check. The readable indicia may be visibly displayed to deter counterfeiting. In FIG. 9, an authorized user (e.g., a bank clerk) at a first financial institution (e.g., a bank) initiates a print check request (block 901). A print device 101 may be used to initiate the print check request and may confirm that the user is authorized to make the print check request. Once authorization has been confirmed, the print device 101 prompts the authorized user to provide the information to be included in the readable indicia (block 902). The information entered by the authorized user may include financial information such as, for example, the ABA/routing information, the branch number of the first financial institution, the check number, the check amount, and any private information that may be cross-referenced with other financial institutions (block 903). The print device 101 then generates metadata corresponding to the information input by the authorized user (block 904), and transmits the metadata to the remote server 103, where a readable indicia (e.g., a barcode) having various encryption levels is generated. The desired encryption level may be specified by the authorized user.

Once the metadata has been generated at the first financial institution and transmitted to the remote server 103, a checksum is calculated (block 905) and the metadata and the checksum are encrypted (block 906). The checksum may be generated using the client ID of the print device 101. For example, different print devices having different client IDs will result in the generation of different checksums. Further, different checksum algorithms may be used for different print devices. Varying encryption levels may be used as requested by the first financial institution. The metadata and the checksum are recorded in a database 104 at the remote server 103 (block 907), and the readable indicia including the encrypted metadata and the checksum is generated (block 908) and returned to the first financial institution.

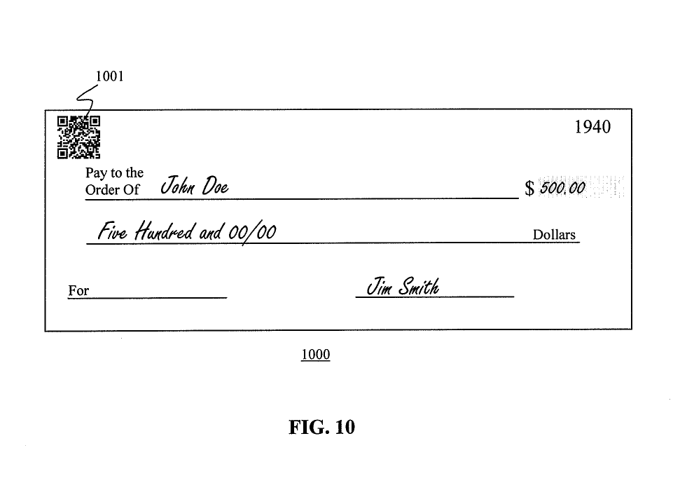

At the first financial institution, the print device 101 prints the check, which includes standard information typically included on a check (e.g., the check amount, the date, the payor, and the payee), as well as the readable indicia generated at the remote server 103 (block 909). The remote server 103 is notified when the check is printed (block 910). An example of a check 1000 including the readable indicia 1001 embodied as a QR code is shown in FIG. 10.

When the check is delivered to the intended customer by the first financial institution, the readable indicia on the check is scanned (block 911). Upon scanning the readable indicia, information identifying the scanning device 102 (e.g., private metadata) is transmitted to the remote server 103 and recorded in the database 104 (block 912). The information recorded in the database 104 may include, but is not limited to, the type of scanning device 102, the ID of the scanning device 102, the IP address of the scanning device 102, the date and time that the scanning occurred, and the location where the scanning occurred.

When the recipient of the check attempts to deposit the check at a second financial institution (e.g., another bank or a convenience store with check cashing services) (block 913), a mobile application registered to the second financial institution scans the readable indicia on the check (block 914). Upon scanning the readable indicia, information identifying the place of the attempted deposit is transmitted to the remote server 103 and recorded in the database 104 (block 915). The information recorded in the database 104 may include, but is not limited to, the type of scanning device 102, the ID of the scanning device 102, the IP address of the scanning device 102, the date and time that the scanning occurred, and the location where the scanning occurred.

The mobile application then makes a request to the remote server 103 to decrypt the encrypted information, where it is decrypted (block 916). The decrypted public metadata is returned to the mobile application at the second financial institution. The user of the mobile application may then compare the decrypted public metadata with the information printed on the check to identify any alterations (block 917). If the information matches, the user completes the transaction. If the information does not match, the check is identified as a counterfeit check.

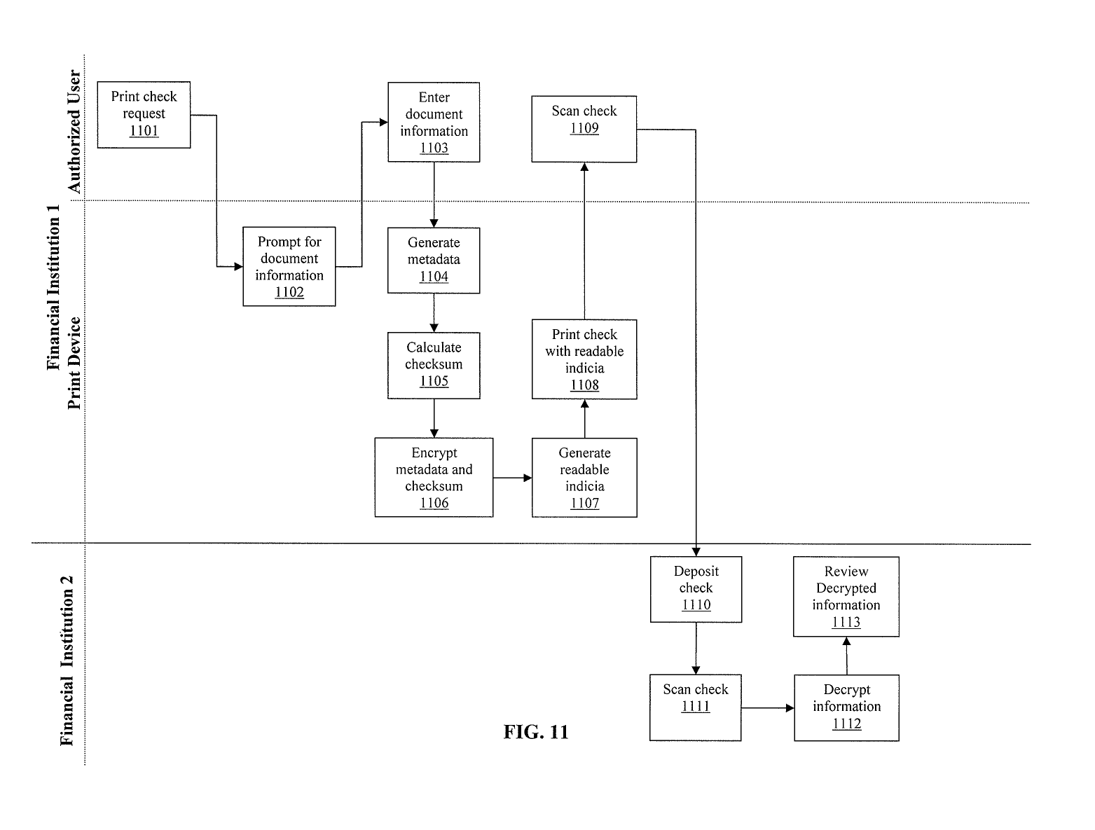

FIG. 11 illustrates a method of localized document tracking, authentication, and counterfeit detection, according to an exemplary embodiment. For purposes of illustration, FIG. 11 shows the tracking and authentication of bank checks, and the detection of counterfeit bank checks using the counterfeit detection system. However, as will be appreciated by one having ordinary skill in the art, the method as described in reference to FIG. 11 is not limited to bank checks.

Referring to FIG. 11, localized document tracking and authentication, and counterfeit detecting does not utilize a remote server for storing or processing information. For example, a print device 101 used during the localized document tracking and authentication method may include an embedded programmable logic device capable of calculating and verifying a checksum and encrypting information such as public metadata, protected metadata, and private metadata. The public metadata may include, for example, ABA/routing information, the check date and time, or the check amount). The private metadata may include, for example, an IP address of the print device 101, a location of the print device 101, or a CPU serial number of the print device 101. A mobile application loaded onto a device such as, for example, a smartphone, may scan readable indicia on the check, decrypt the information stored in the readable indicia, verify the checksum accuracy, and display the public metadata on the device.

In FIG. 11, an authorized user (e.g., a bank clerk) makes a print check request (block 1101). Upon making the request, a print device 101 prompts the user to provide the information to be included in the readable indicia (block 1102). The information entered by the authorized user may include financial information such as, for example, the ABA/routing information, the branch number of the first financial institution, the check number, the check amount, and any private information that may be cross-referenced with other financial institutions (block 1103). The print device 101 then generates metadata using the information input by the authorized user (block 1104). Software loaded onto the print device 101 may append additional private metadata to the generated metadata such as, for example, information identifying the print device 101 and the location of the print device 101. A checksum is then calculated by the print device 101 (block 1105). The generated metadata and checksum are then encrypted by the print device 101 (block 1106), the readable indicia including the encrypted checksum and metadata is generated by the print device 101 (block 1107), and a check including the readable indicia is printed by the print device 101 (block 1108). The readable indicia on the printed check is then scanned by the authorized user (block 1109), and the check is presented to the recipient.

When the recipient of the check attempts to deposit the check at a second financial institution (block 1110) (e.g., a bank or a convenience store with check cashing services), an authorized user (e.g., a bank clerk or a store clerk) scans the readable indicia on the check with a mobile application registered to the second financial institution (block 1111). The registered mobile application decrypts the checksum and the encrypted metadata and verifies the checksum accuracy (block 1112). If the checksum is not verified, the authorized user is alerted. The authorized user then compares the public metadata displayed by the mobile application with the information printed on the check (block 1113). If the information matches, the transaction is completed. If the information does not match, the check is identified as a counterfeit check.

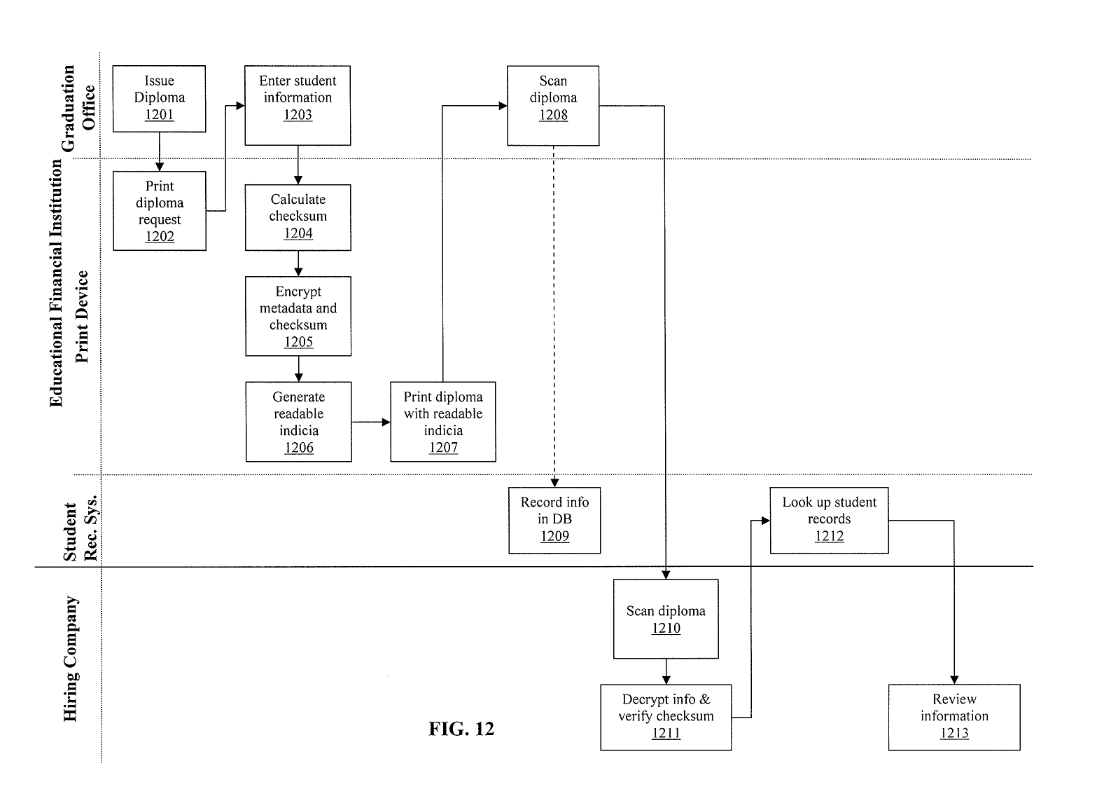

FIG. 12 illustrates a method of document tracking and authentication, and counterfeit detection, according to an exemplary embodiment. For purposes of illustration, FIG. 12 shows the tracking and authentication of diplomas and transcripts, and the detection of counterfeit diplomas and transcripts using the counterfeit detection system. However, as will be appreciated by one having ordinary skill in the art, the method as described in reference to FIG. 12 is not limited to diplomas and transcripts or educational settings.

Referring to FIG. 12, an authorized user at an educational institution (e.g., a college university) issues a diploma to a graduating student (block 1201). For example, an office clerk in the educational institution's graduation office first makes a print diploma request (block 1202). Software loaded on a print device 101 prompts the office clerk to provide information about the diploma such as, for example, public metadata including, but not limited to, the student's name and graduation date, and protected metadata including, but not limited to, a student ID for cross-referencing databases at the educational institution (block 1203). The print device 101 may also append private metadata to the metadata provided by the office clerk such as, for example, an IP address of the print device 101, a location of the print device 101, or a CPU serial number of the print device 101. A checksum is then calculated by the print device 101 (block 1204), and the metadata and checksum are encrypted by the print device 101 (block 1205). The print device 101 then generates a readable indicia including the encrypted metadata and checksum (block 1206), and prints a diploma including the readable indicia and other student information (block 1207). The office clerk scans the readable indicia before the diploma is delivered to the student (block 1208), and the information stored in the readable indicia is stored in a database at the educational institution (block 1209).

When the student applies for a job at a company and presents the diploma, an authorized user at the company scans the readable indicia on the diploma with an application registered to the company (block 1210). The application may be, for example, a mobile application loaded onto a mobile device such as a smartphone. The mobile application decrypts the encrypted metadata and checksum and verifies the checksum (block 1211). The authorized user then compares the decrypted information with the information printed on the diploma to identify any alterations (block 1213) made to the diploma. In an exemplary embodiment, the encrypted metadata and checksum may be decrypted at the educational institution and the checksum may be verified at the educational institution. Further, in an exemplary embodiment, the mobile application may access student records via the educational institution's student records system using protected metadata (e.g., a student ID) to retrieve information not included on the diploma (block 1212). For example, the authorized user may not be permitted to view the protected metadata, but the authorized user may be permitted to retrieve other information such as, for example, student transcripts, student grades, and a student picture using the protected metadata.

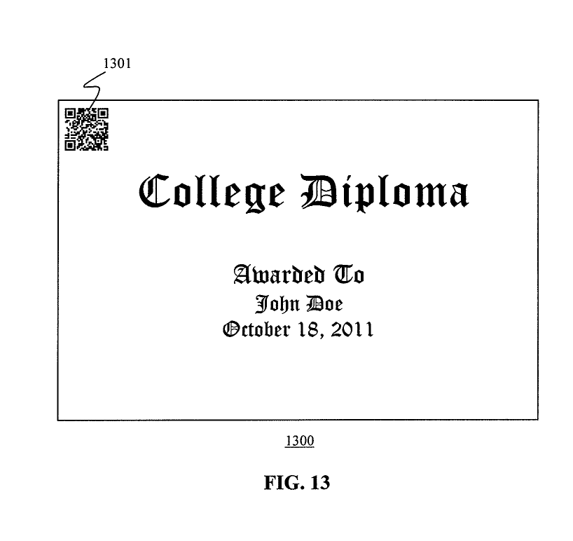

FIG. 13 illustrates an example of a diploma 1300 printed using the method of FIG. 12 and including readable indicia embodied as a QR code 1301.

As described above, a checksum may be used for detecting accidental errors in data that may occur during transmission or storage, as well as intentional alterations of data. The integrity of the data may be checked at any time by recomputing the checksum and comparing the computed checksum with the stored checksum. If the checksums match, the data was most likely not altered. The procedure that yields the checksum from the data is referred to as a checksum function. The checksum function used in exemplary embodiments of the present disclosure may be, for example, a longitudinal parity check function, a parity byte function, a parity word function, an MD5 Message-Digest algorithm, or a Secure Hash Algorithm (e.g., SHA, SHA-2, SHA-224, SHA-256, SHA-384, SHA-512), however the checksum function is not limited thereto.

As will be appreciated by one skilled in the art, aspects of the present disclosure, including, but not limited to, the counterfeit product detection methods and document tracking, authentication, and counterfeit detection methods described above, may be embodied as a system, method, computer program product, or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain, or store a program for use by or in connection with an instruction execution system, apparatus, or device.

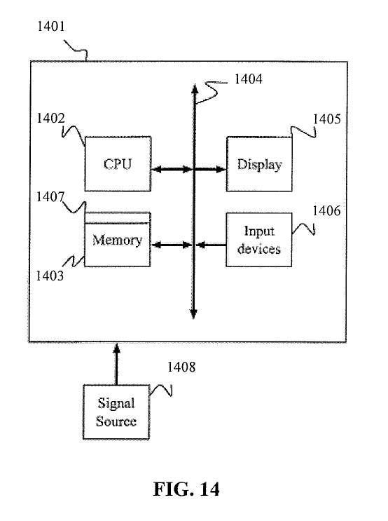

FIG. 14 is a computer system for implementing a method of detecting counterfeit products and documents, and tracking and authenticating documents, according to an exemplary embodiment of the present disclosure.

Referring to FIG. 14, according to an exemplary embodiment of the present disclosure, a computer system 1401 for detecting counterfeit products and documents, and tracking and authenticating documents may include, inter alia, a central processing unit (CPU) 1402, a memory 1403 and an input/output (I/O) interface 1404. The computer system 1401 is generally coupled through the I/O interface 1404 to a display 1405 and various input devices 1406 such as a mouse and keyboard. The support circuits can include circuits such as cache, power supplies, clock circuits, and a communications bus. The memory 1403 can include random access memory (RAM), read only memory (ROM), disk drive, tape drive, etc., or a combination thereof. Embodiments of the present disclosure may be implemented as a routine 1407 stored in memory 1403 (e.g., a non-transitory computer-readable storage medium) and executed by the CPU 1402 to process the signal from the signal source 1408. As such, the computer system 1401 is a general-purpose computer system that becomes a specific purpose computer system when executing the routine 1407 of the present disclosure.

The computer platform 1401 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

Having described embodiments for detecting counterfeit products and documents, and tracking and authenticating documents, it is noted that modifications and variations can be made by persons skilled in the art in light of the above teachings. It is therefore to be understood that changes may be made in exemplary embodiments of the disclosure, which are within the scope and spirit of the disclosure as defined by the appended claims. Having thus described exemplary embodiments of the disclosure with the details and particularity required by the patent laws, what is claimed and desired protected by Letters Patent is set forth in the appended claims.

1-65. (canceled)

66. A method of product counterfeit detection, comprising:
disposing a readable indicia comprising a unique identification (ID) code on a product;
generating scan data upon scanning the readable indicia with a scanning device, wherein the scan data comprises the unique ID code, a scanning device identification (ID) code and a scan location;
transmitting the scan data to a remote server;
linking the unique ID code, the scanning device ID code, and the scan location in an electronic database at the remote server;
incrementing a first counter upon determining that the scanning device ID code and the scan location have not been previously linked to the unique ID code in the electronic database; and
flagging the unique ID code as counterfeit upon determining that the first counter exceeds a counterfeiting threshold.

67. The method of claim 66, further comprising loading an application onto the scanning device, wherein the readable indicia is a quick response (QR) code, the scanning device is a mobile phone comprising a camera configured to read the QR code, and the application is configured to interface with the electronic database.

68. The method of claim 66, further comprising loading an application onto the scanning device, wherein the readable indicia is a radio-frequency identification (RFID) tag, the scanning device is a mobile phone comprising an RFID radio configured to read the RFID tag, and the application is configured to interface with the electronic database.

69. The method of claim 66, further comprising:
incrementing a second counter each time the flagged unique ID code is scanned at the scan location; and
flagging the scan location as a counterfeit zone upon the second counter exceeding a counterfeit zone threshold.

70. The method of claim 69, further comprising:
transmitting a counterfeit zone notification to a law enforcement authority upon flagging the scan location as a counterfeit zone.

71. The method of claim 66, further comprising:
transmitting a counterfeit product notification to the scanning device upon flagging the unique ID code as counterfeit.

72. The method of claim 66, wherein the scan location is determined using electromagnetic signals received by the scanning device.

73. The method of claim 66, wherein the scanning device is a mobile phone comprising a cellular radio and at least one of a global positioning satellite (GPS) radio and a Wi-Fi radio, and the scan location is determined using at least one of the cellular radio, the GPS radio, or the Wi-Fi radio.

74. The method of claim 66, further comprising:
requesting the unique ID code, wherein the request is made by a product manufacturer;
generating the unique ID code, wherein the unique ID code is generated by the remote server, and the remote server is located separate from the product manufacturer;
recording the unique ID code in the electronic database at the remote server;
transmitting the unique ID code from the remote server to the product manufacturer;
assigning the unique ID code to a product, wherein the unique ID code is assigned to the product by the product manufacturer; and
generating the readable indicia comprising the unique ID code, wherein the readable indicia is generated by the product manufacturer.

75. A method of product counterfeit detection, comprising:
disposing a readable indicia comprising a unique identification (ID) code on a product;
generating scan data upon scanning the readable indicia with a scanning device, wherein the scan data comprises the unique ID code, a scanning device identification (ID) code and a scan location;
transmitting the scan data to a remote server;
linking the unique ID code, the scanning device ID code, and the scan location in an electronic database at the remote server; and
flagging the unique ID code as counterfeit upon determining that the unique ID code is linked to a different scanning device ID code and a different scan location in the remote electronic database.

76. The method of claim 75, further comprising loading an application onto the scanning device, wherein the readable indicia is a quick response (QR) code, the scanning device is a mobile phone comprising a camera configured to read the QR code, and the application is configured to interface with the electronic database.

77. The method of claim 75, further comprising:
transmitting user registration data to the remote server upon a user registering as an owner of the product; and
transmitting a counterfeit notification to the registered owner upon flagging the unique ID code as counterfeit.

78. The method of claim 75, further comprising:
requesting the unique ID code, wherein the request is made by a product manufacturer;
generating the unique ID code, wherein the unique ID code is generated by the remote server, and the remote server is located separate from the product manufacturer;
recording the unique ID code in the electronic database at the remote server;
transmitting the unique ID code from the remote server to the product manufacturer;
assigning the unique ID code to a product, wherein the unique ID code is assigned to the product by the product manufacturer; and
generating the readable indicia comprising the unique ID code, wherein the readable indicia is generated by the product manufacturer.

79. A method of grey market commerce detection, comprising:
disposing a readable indicia comprising a unique identification (ID) code on a product;
transmitting product exclusivity data to a remote server, wherein the product exclusivity data indicates whether the unique ID code is designated for sale in an exclusive market or a nonexclusive market;
generating scan data upon scanning the readable indicia with a scanning device, wherein the scan data comprises the unique ID code and a scan location;
transmitting the scan data to the remote server; and
flagging commerce as grey market commerce upon determining that the product was purchased in an exclusive market based on the scan location, and the product was not designated for sale in the exclusive market based on the product exclusivity data.

80. The method of claim 79, further comprising loading an application onto the scanning device, wherein the readable indicia is a quick response (QR) code, the scanning device is a mobile phone comprising a camera configured to read the QR code, and the application is configured to interface with the electronic database.

81. The method of claim 79, further comprising:
flagging the scan location as a grey market commerce location upon flagging the commerce as grey market commerce.

82. The method of claim 81, further comprising:
transmitting a grey market commerce alert comprising the scan location to a client upon flagging the commerce as grey market commerce, wherein the readable indicia has been disposed on the product by the client.

83. The method of claim 79, further comprising:
requesting the unique ID code, wherein the request is made by a product manufacturer;
generating the unique ID code, wherein the unique ID code is generated by the remote server, and the remote server is located separate from the product manufacturer;
recording the unique ID code in the electronic database at the remote server;
transmitting the unique ID code from the remote server to the product manufacturer;
assigning the unique ID code to a product, wherein the unique ID code is assigned to the product by the product manufacturer; and
generating the readable indicia comprising the unique ID code, wherein the readable indicia is generated by the product manufacturer.

84. A method of tracking and authenticating a document, comprising:
receiving public metadata and protected metadata corresponding to the document from an originating source, wherein access to the public metadata is unrestricted and access to the protected metadata is restricted to at least one authorized entity;
generating private metadata comprising information indicating the originating source, wherein the private metadata is automatically altered upon a scan operation occurring, and cannot be altered otherwise;
generating a readable indicia corresponding to the public, protected, and private metadata; and
affixing the readable indicia to the document.

85. The method of claim 84, wherein the public, protected, and private metadata are stored in an electronic database in a remote server, and the readable indicia comprises a pointer to the public, protected, and private metadata.

86. The method of claim 84, wherein the public and protected metadata are stored in the readable indicia, the private metadata is stored in an electronic database in a remote server, and the readable indicia comprises a pointer to the private metadata.

87. The method of claim 84, further comprising:
generating a checksum incorporating one or more element of each of the public, protected, and private metadata; and
encrypting the public, protected, and private metadata, and the checksum,
wherein the checksum is generated at a remote server, and the public, protected, and private metadata, and the checksum are encrypted at the remote server.

88. The method of claim 84, further comprising:
scanning the readable indicia with a scanning device to obtain the encrypted public, protected, and private metadata, and the encrypted checksum;
decrypting the public, protected, and private metadata, and the checksum at the scanning device; and
displaying the decrypted public, protected, and private metadata, and the checksum on the scanning device.

89. The method of claim 84, further comprising:
scanning the readable indicia with a scanning device to obtain the encrypted public, protected, and private metadata, and the encrypted checksum;
transmitting the encrypted public, protected, and private metadata, and the encrypted checksum from the scanning device to a remote server;
decrypting the encrypted public, protected, and private metadata, and the encrypted checksum at the remote server; and
transmitting the decrypted public, protected, and private metadata, and the decrypted checksum from the remote server to the scanning device.

90. The method of claim 84, further comprising:
storing the public metadata, the protected metadata, and the private metadata in an electronic database at a remote server;
scanning the readable indicia with a scanning device to obtain the encrypted public, protected, and private metadata, and the encrypted checksum;
transmitting the encrypted public, protected, and private metadata, and the encrypted checksum from the scanning device to the remote server;
decrypting the public, protected, and private metadata, and the checksum at the remote server;
generating a comparison result at the remote server, wherein the comparison result is obtained by comparing the public, protected, and private metadata, and the checksum stored in the electronic database, with the decrypted public, protected, and private metadata, and the decrypted checksum received from the scanning device;
transmitting the comparison result from the remote server to the scanning device; and
displaying the comparison result on the scanning device.

91. The method of claim 84, further comprising:
scanning the readable indicia with a scanning device; and
appending identifying information to the private metadata, automatically, upon scanning the readable indicia, wherein the identifying information identifies the scanning device.

92. The method of claim 84, further comprising:
retrieving document-related information using the protected metadata, wherein the document-related information comprises information that is not included on the document.

93. The method of claim 84, wherein the readable indicia is one of a quick response (QR) code or a radio-frequency identification (RFID) tag.

94. The method of claim 84, wherein the originating source is a financial institution, the document is a check, and the public metadata comprises routing information corresponding to the financial institution, a branch number corresponding to the financial institution, a check number of the check, and an amount of the check.

95. The method of claim 84, further comprising:
retrieving a student transcript corresponding to a student diploma,
wherein the originating source is an educational institution, the at least one authorized entity is an employer, the document is the student diploma, the protected metadata comprises a student identification (ID) code, and the student transcript is retrieved by the employer from the educational institution using the student ID code.

96. The method of claim 84, wherein the private metadata is automatically altered by an application loaded onto a scanning device that performs the scan operation.
